(19) United States
(12) Patent Application Publication
(10) Pub. No.: US 2010/0321754 A1
(43) Pub. Date: Dec. 23, 2010

(54) WAVELENGTH SELECTIVE SWITCH

(75) Inventors: Hiromu IKEDA, Kokubunji-shi (JP); Shohei KOBAYASHI, Hino-shi (JP)

Correspondence Address: SCULLY SCOTT MURPHY & PRESSER, PC, 400 GARDEN CITY PLAZA, SUITE 300, GARDEN CITY, NY, 11530, US

(73) Assignee: OLYMPUS CORPORATION, Tokyo (JP)

(21) Appl. No.: 12/814,888

(22) Filed: Jun. 14, 2010

(30) Foreign Application Priority Data
Jun. 22, 2009 (JP) 2009-147889

(51) Int. Cl. G02B 26/08

(52) U.S. Cl. 359/225.1

(57) ABSTRACT

A wavelength selective switch includes a port array including three or more input and output ports arranged on a first plane in which first and second axes lie along the first axis, a dispersive element to disperse a light beam launched from an input port in a second plane in which the second axis and a third axis lie, a focusing optical element to focus dispersed light beams, and a mirror array to couple a focused light beam to an output port through the elements. The array has a mirror substrate arranged across the second plane. The substrate includes movable mirrors arranged in a line and allowed to be two-dimensionally tilted. The substrate is arranged so that its surface facing the focusing optical element has a tilt angle about the first axis with respect to a third plane in which the third and first axes lie.

### CROSS-REFERENCE TO RELATED APPLICATIONS

This application is based upon and claims the benefit of priority from prior Japanese Patent Application No. 2009-147889, filed Jun. 22, 2009, the entire contents of which are incorporated herein by reference.

### BACKGROUND OF THE INVENTION

1. Field of the Invention

The present invention relates to a wavelength selective switch.

2. Description of the Related Art

JP-A 2007-212678 (KOKAI) discloses a wavelength selective switch. This wavelength selective switch includes a port array including an input port and output ports, a spectral element to divides a light beam dispersed from the input port into a plurality of light beams, a focusing lens to focus the divided light beams, and a mirror array to reflect the light beams with movable mirrors to direct them to desired output ports, respectively. The mirror array is arranged perpendicularly to an optical axis of the focusing lens. In the wavelength selective switch, since the mirror array is arranged perpendicularly to the optical axis of the focusing lens, the light reflected by a portion of the mirror array excluding the movable mirrors, stray light, is partially coupled to the port array. Such coupling of the stray light to the port array causes a reduction in performance of the wavelength selective switch, which should be decreased.

### BRIEF SUMMARY OF THE INVENTION

The present invention has been made in consideration of these situations, and an object of the present invention is to provide a wavelength selective switch in which coupling of the stray light to the port array is reduced.

A wavelength selective switch includes a port array including three or more input and output ports arranged on a first plane in which a first axis and a second axis perpendicular to the first axis lie and aligned along the first axis. An input port launches a light beam in substantially parallel to the second axis. The switch also includes a spectral element to disperse the light beam launched from the input port in a plane that is substantially parallel to a second plane in which a third axis perpendicular to the first axis and the second axis and the second axis lie, a focusing optical element to focus light beams dispersed by the spectral element, and a mirror array to selectively couple one of the light beams focused by the focusing optical element to an output port through the focusing optical element and the spectral element. The mirror array has a mirror substrate arranged across the second plane. The mirror substrate includes movable mirrors that are arranged in a line and allowed to be two-dimensionally tilted. The mirror substrate is arranged so that its surface facing the focusing optical element has a tilt angle about an axis substantially parallel to the first axis with respect to a third plane in which the third axis and the first axis lie.

According to the present invention, a wavelength selective switch in which coupling of the stray light to the port array is reduced is provided.

Advantages of the invention will be set forth in the description which follows, and in part will be obvious from the description, or may be learned by practice of the invention. Advantages of the invention may be realized and obtained by means of the instrumentalities and combinations particularly pointed out hereinafter.

### BRIEF DESCRIPTION OF THE SEVERAL VIEWS OF DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 shows a wavelength selective switch according to an embodiment of the present invention;

FIG. 2 is a side view of the wavelength selective switch depicted in FIG. 1;

FIG. 3 is a top view of the wavelength selective switch depicted in FIG. 1;

FIG. 4 shows an example of the mirror array depicted in FIG. 1, FIG. 2 and FIG. 3;

FIG. 5 shows one mirror unit in the mirror array depicted in FIG. 4; and

FIG. 6 shows arrangement of the mirror array depicted in FIG. 4.

### DETAILED DESCRIPTION OF THE INVENTION

An embodiment of the present invention will now be described hereinafter with reference to the accompanying drawings.

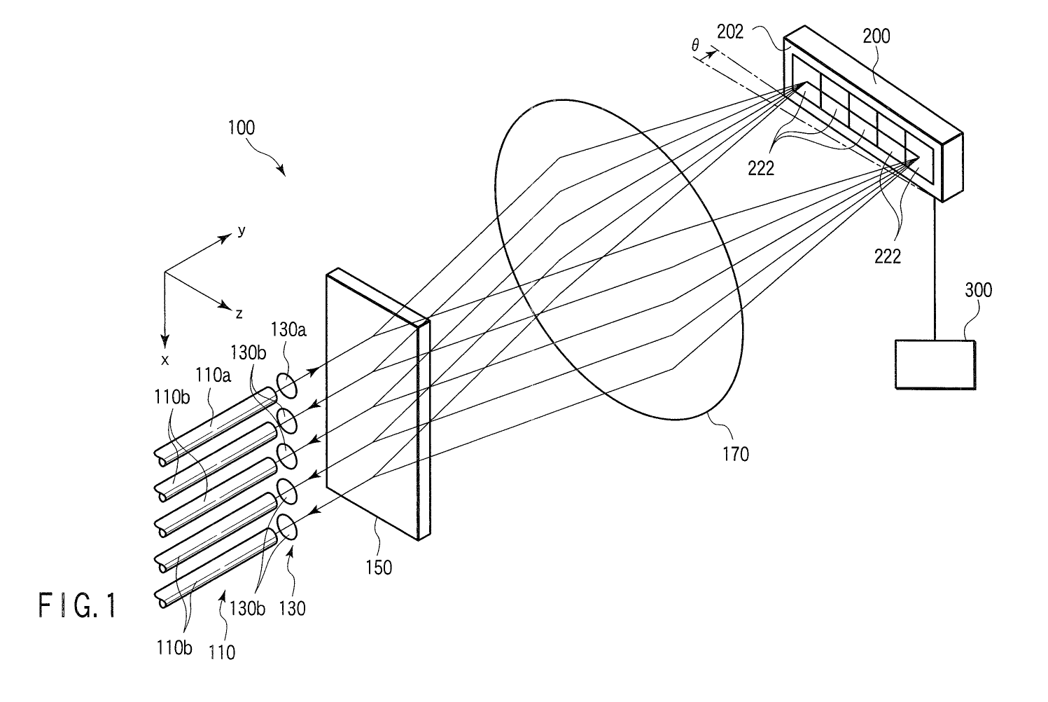

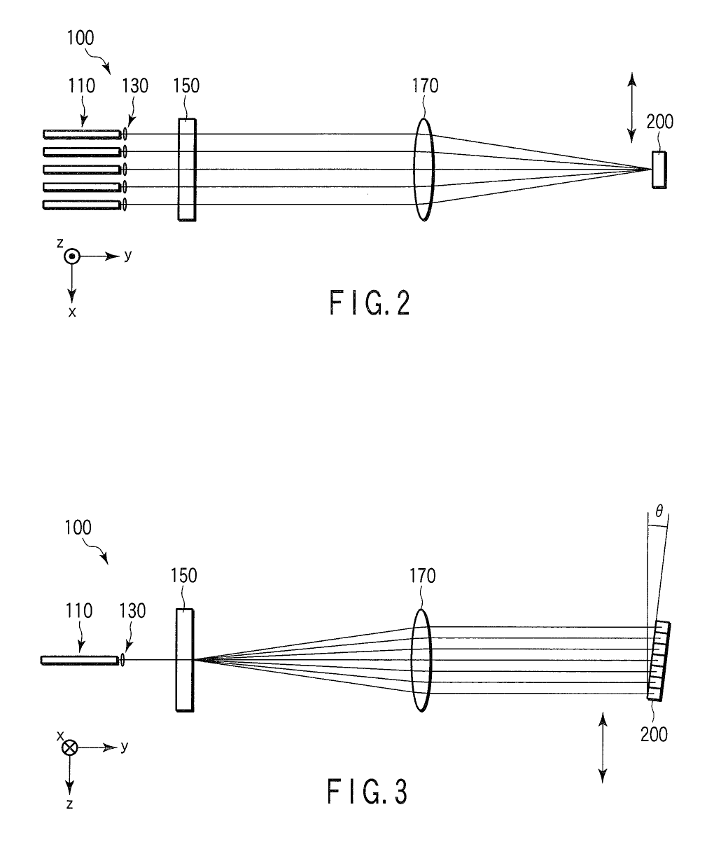

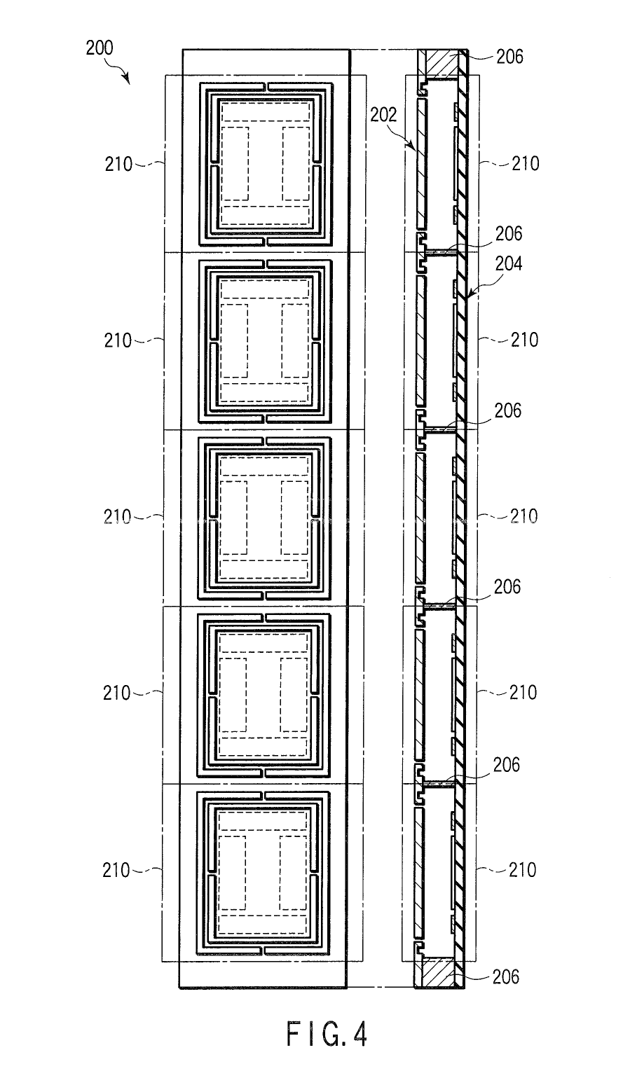

FIG. 1, FIG. 2 and FIG. 3 show a wavelength selective switch according to the embodiment of the present invention. In order to facilitate understanding, an xyz rectangular coordinate system is set as shown in FIG. 1. In the xyz rectangular coordinate system, an x axis (a first axis), a y axis (a second axis), and a z axis (a third axis) are perpendicular to each other. An xy plane (a first plane) is a plane in which the x axis (the first axis) and the y axis (the second axis) lie. Likewise, a yz plane (a second plane) is a plane in which the y axis (the second axis) and the z axis (the third axis) lie. A zx plane (a third plane) is a plane in which the z axis (the third axis) and the x axis (the first axis) lie. In the following expression, for example, the term “xy plane” does not mean one specific plane, but it typically means one of an infinite number of planes parallel to the illustrated plane in which the x axis and the y axis lie. This can be likewise applied to the yz plane and the zx plane.

A wavelength selective switch 100 has a port array 110, a lens array 130, a dispersive element 150, a focusing optical element 170, a mirror array 200, and a control unit 300.

The port array 110 includes input and output ports 110a and 110b. A total of the number of the input and output ports 110a and 110b is three or more. An input port 110a is a port to which light is input from the outside of the wavelength selective switch 100, and an output port 110b is a port from which light is output to the outside of the wavelength selective switch 100. The input and output ports 110a and 110b are arranged on the xy plane and aligned along the x axis. An input port 110a launches a light beam in substantially parallel to the y axis.

The wavelength selective switch 100 is, e.g., a wavelength selective switch having 1 input and N outputs or a wavelength selective switch having N inputs and 1 output. When the wavelength selective switch 100 is the wavelength selective switch having 1 input and N outputs, the port array 110 has an input port 110a and a plurality of output ports 110b. And, when the wavelength selective switch 100 is the wavelength selective switch having N inputs and 1 output, the port array 110 has a plurality of input ports 110a and an output port 110b.

In FIG. 1, the wavelength selective switch 100 is illustrated as the wavelength selective switch having 1 input and N outputs. That is, the port array 110 has an input port 112 and a plurality of, e.g., 4, output ports 114. As persons skilled in the art can naturally understand, the wavelength selective switch 100 can be formed as the wavelength selective switch having N inputs and 1 output by counterchanging purposes of the input port and the output ports.

The lens array 130 includes input and output lenses 130a and 130b. The number of the input and output lenses 130a and 130b is the same as the number of the input and output ports 110a and 110b. An input lens 130a, which is arranged to face an end face of the input port 110a, is configured to collimate the light beam launched from the input port 110a. An output lens 130b, which is arranged to face an end face of the corresponding output port 110b, is configured to focus the incident light to direct it into the output port 110b.

The dispersive element 150 is configured to disperse the light beam launched from the input port 110a in a plane substantially parallel to the yz plane in accordance with a wavelength. That is, the dispersive element 150 has a function of separating light containing wavelength components that comes in along the y axis into a plurality of light beams having different wavelength components and of deflecting these light beams in different directions in the yz plane in accordance with each wavelength component. Furthermore, the dispersive element 150 also has a function of deflecting a light beam that comes in parallel to the yz plane at an incidence angle equal to a deflection angle at the light dispersion to be parallel to the y axis.

Such a dispersive element 150 may be formed of, but not limited to, e.g., a diffraction grating. Although the dispersive element 150 is shown as a transmission type dispersive element in FIG. 1, it may be changed to a reflection type dispersive element. The wavelength selective switch having such a configuration has an optical function which is substantially equal to that of the wavelength selective switch according to this embodiment.

The focusing optical element 170 is configured to focus the light beams dispersed by the dispersive element 150. The focusing optical element 170 has a function of converging light beams separated by the dispersive element 150 in accordance with each wavelength and appropriately deflecting the light beams in the x axis direction and the z axis direction in accordance with an incidence angle thereof.

As shown in FIG. 1, such a focusing optical element 170 may be formed of a transmission type focusing optical element, e.g., a focusing lens. However, the focusing optical element 170 is not limited thereto, and it may be formed of a reflection type focusing optical element such as a concave mirror. The wavelength selective switch having such a configuration has an optical function substantially equal to that of the wavelength selective switch according to this embodiment.

The mirror array 200 is configured to selectively couple one of the light beams focused by the focusing optical element 170 to an output port 110b through the focusing optical element 170, the dispersive element 150, and the lens array 130. Herein, selectively coupling the light beam to the output port 110b means coupling a light beam having a specific wavelength component to any one of the output ports 110b in the wavelength selective switch having 1 input and N outputs. Moreover, it means coupling any one of light beams having wavelength components to an output port 110b in the wavelength selective switch having N inputs and 1 output.

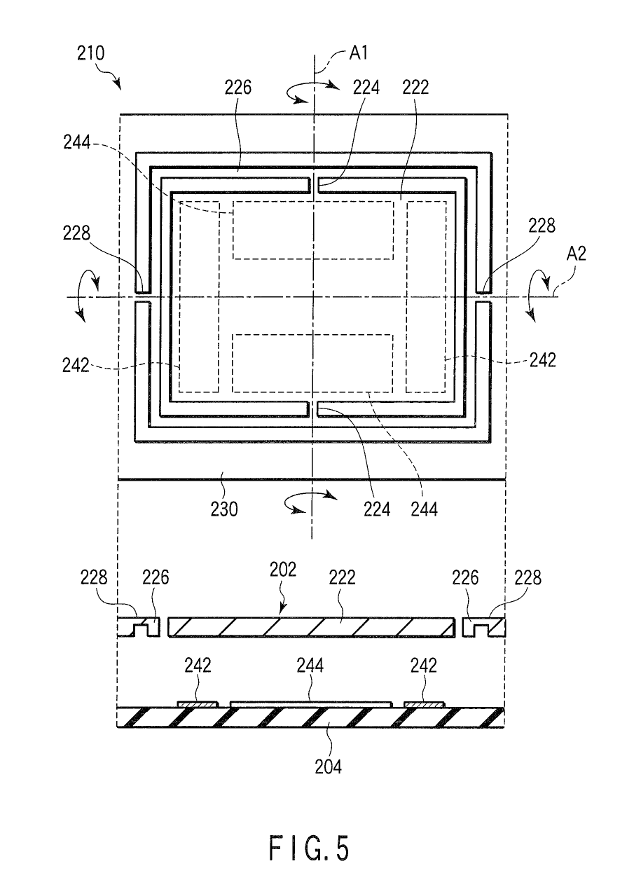

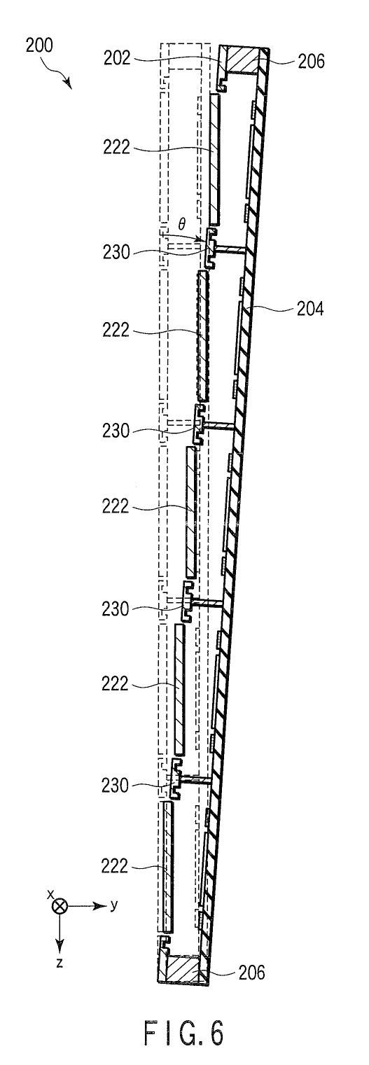

An electrostatic drive type mirror array will now be taken as a typical example to describe the mirror array 200 in more detail. FIG. 4, FIG. 5 and FIG. 6 show a schematic configuration of a 2-axis driving mirror array which is of the electrostatic drive type.

Although the mirror array 200 is not limited thereto, it can be formed of, e.g., an MEMS micro mirror array manufactured based on a microelectromechanical system (MEMS).

As shown in FIG. 4, the mirror array 200 has a mirror substrate 202, a driving substrate 204, and a spacer 206. The mirror substrate 202 is coupled to the driving substrate 204 through the spacer 206, and they are arranged in parallel to each other at a predetermined interval.

The mirror array 200 has mirror units 210. The mirror units 210 are aligned in a straight line.

FIG. 5 shows a configuration of one mirror unit 210. One mirror unit 210 will now be described hereinafter with reference to FIG. 5.

The mirror substrate 202 has, for each mirror unit 210, a movable mirror 222 having a reflecting surface, a movable frame 226 placed around the movable mirror 222, a pair of hinges 224 connecting the movable mirror 222 and the movable frame 226, a fixed frame 230 placed around the movable frame 226, and a pair of hinges 228 connecting the movable frame 226 and the fixed frame 230. The hinges 224 support the movable mirror 222 to allow it to be tilted about an axis A1 with respect to the movable frame 226, and the hinges 228 support the movable frame 226 to allow it to be tilted about an axis A2 with respect to the fixed frame 230. The fixed frame 230 is fixed to the driving substrate 204 through the spacer 206. Accordingly, the movable mirror 222 is allowed to be tilted about the axis A1 and the axis A2 with respect to the fixed frame 230. That is, the movable mirror 222 is allowed to be two-dimensionally tilted.

The driving substrate 204 has, for each mirror unit 210, a pair of driving electrodes 242 and a pair of driving electrodes 244 on a surface facing the mirror substrate 202. Both the driving electrodes 242 and the driving electrodes 244 face the movable mirror 222. The pair of driving electrodes 242 is distanced from each other along the axis A2 and they are arranged to be line-symmetrical with respect to the axis A1. Each driving electrode 242 has a shape that is line-symmetrical with respect to the axis A2. The pair of driving electrodes 244 is distanced from each other along the axis A1, and they are arranged to be line-symmetrical with respect to the axis A2. Each driving electrode 244 has a shape that is line-symmetrical with respect the axis A1.

In the mirror unit 210, for example, when a voltage is applied to one driving electrode 242, an electrostatic force is generated in a space between the driving electrode 242 having the voltage applied thereto and the movable mirror 222 facing the driving electrode 242, and the movable mirror 222 facing the driving electrode 242 having the voltage applied thereto is attracted to the driving substrate 204. As a result, the movable mirror 222 is tilted about the axis A1 at an angle associated with the electrostatic force. When the voltage is applied to the other driving electrode 242, the movable mirror 222 is tilted in an opposite direction.

Furthermore, for example, when the voltage is applied to one driving electrode 244, the electrostatic force is generated in a space between the driving electrode 244 having the voltage applied thereto and a portion of the movable mirror 222 facing the driving electrode 244. As a result, the movable mirror 222 is tilted about the axis A2 at an angle associated with the electrostatic force together with the movable frame 226. When the voltage is applied to the other driving electrode 244, the movable mirror 222 is tilted in the opposite direction.

Herein, although the electrostatic drive type mirror array is taken as an example of the mirror array 200, the mirror array 200 used in the wavelength selective switch depicted in FIG. 1 is not limited to the electrostatic drive type, and any other driving system, e.g., the electrostatic drive type, an electromagnetic drive type or a piezoelectric actuation type can be adopted.

As shown in FIG. 1, FIG. 3 and FIG. 6, the mirror array 200 is arranged so that the axis A1 of each mirror unit 210 becomes parallel to the xy plane, e.g., the x axis. Accordingly, the mirror substrate 202 and the driving substrate 204 are arranged across the yz plane. Moreover, the mirror substrate 202 is arranged so that its surface facing the focusing optical element 170, e.g., the portion of the fixed frame 230 has a tilt angle θ (≠0) about an axis substantially parallel to at least the x axis with respect to the zx plane. The mirror substrate 202 may be also arranged so that its surface facing the focusing optical element 170 has a tilt angle about an axis substantially parallel to the z axis with respect to the zx plane. That is, a tilt direction of the surface of the mirror substrate 202 facing the focusing optical element 170 with respect to the zx plane has a component parallel to at least the z axis. In other words, when the tilt of the surface of the mirror substrate 202 facing the focusing optical element 170 with respect zx plane is decomposed into a component about the x axis and a component about the z axis, it has at least the component about the x axis that is equal to the tilt angle θ.

The driving substrate 204 is arranged in parallel to the mirror substrate 202. Accordingly, the driving substrate 204 is also arranged so that its surface facing the mirror substrate 202 has the tilt angle θ about an axis that is substantially parallel to at least the x axis with respect to the zx plane.

Furthermore, the driving substrate 204 may be arranged so that its surface facing the mirror substrate 202 also has a tilt angle about an axis that is substantially parallel to the z axis with respect to the zx plane.

In FIG. 1, the control unit 300 is configured to drive the movable mirrors 222 in the mirror array 200. The control unit 300 has a function of appropriately tilting the movable mirrors 222 about the axis A1 and the axis A2.

In FIG. 1, the light beam containing wavelength multiplexed components is launched from the input port 110a along the y axis. Each wavelength multiplexed component of the light beam becomes one channel. The light beam launched from the input port 110a enters the dispersive element 150 through the input lens 130a, and it is separated into light beams in accordance with each channel by the dispersive element 150 and deflected in angular directions associated with the wavelength components in the yz plane. The light beams of the channels are deflected in parallel to the y axis by the focusing optical element 170 to enter the mirror units 210 in the mirror arrays 200, respectively. The light beam of each channel is reflected by the reflecting surface of the movable mirror 222 of the corresponding mirror unit 210.

While the wavelength selective switch 100 is being used, each movable mirror 222 is tilted about the axis A1 with respect to the fixed frame 230 at the tilt angle θ in the direction facing the focusing optical element 170 as shown in FIG. 6. The light beam reflected by the movable mirror 222 is deflected by the focusing optical element 170 to enter the dispersive element 150, and it is deflected to be parallel to the y axis by the dispersive element 150. The light beam defected to be parallel to the y axis by the dispersive element 150 is preferably coupled to any one of the output ports 110b through the output lens 130b. The output port 110b with which the light beam is coupled is determined in accordance with the tilt of the movable mirror 222 about the axis A2. In other words, the output port 110b with which the light beam of each channel is coupled is switched by adjusting the tilt of the movable mirror 222 about the axis A2.

The tilt angle θ is determined in accordance with a function or a specification required for the wavelength selective switch 100.

The tilt angle θ may be set to an angle θ1 at which the coupling carried out between the input port 110a and the port array 110 through the portion of the mirror substrate 202 excluding the movable mirrors 222 is reduced at least approximately 5 dB with respect to the coupling carried out between the input port 110a and the port array 110 through a movable mirror 222 tilted about the axis A1 at the tilt angle θ in a direction heading toward the focusing optical element 170. Herein, the coupling between the input port 110a and the port array 110 means including both the coupling between the input port 110a and the output port 110b and the coupling between the input port 110a and the input port 110a itself.

Light that has entered the portion of the mirror substrate 202 excluding the movable mirrors 222, e.g., the fixed frame 230, the movable frame 226, or the hinges 224 and 228 and light that has struck the driving substrate 204 through the gap of the mirror substrate 202 is reflected by such a member to become stray light. An amount of such stray light is very small, e.g., 30 dB or below, as seen from the entire incident light. Accordingly, when the tilt angle θ is set to such an angle θ1, the coupling of the stray light to the port array 110 is sufficiently suppressed so that the performance of the wavelength selective switch 100 cannot be affected. Accordingly, the wavelength selective switch 100 in which the stray light that is coupled to the port array 110 is reduced without providing a special additional device is provided.

In the wavelength selective switch 100, the tilt angle of each movable mirror 222 about the axis A1 may be adjusted to suppress unevenness in light intensity between channels. This is called attenuation. In the wavelength selective switch 100 that performs such attenuation, the tilt angle θ may be set to, e.g., an angle θ2 at which the coupling carried out between the input port 110a and the output port 110b through a movable mirror 222 that is tilted about the axis A1 at the tilt angle θ in a direction veering off the focusing optical element 170 is reduced approximately 20 dB with respect to the coupling carried out between the input port 110a and the port array 110 through a movable mirror 222 tilted about the axis A1 at the tilt angle θ in a direction heading toward the focusing optical element 170.

Even in the wavelength selective switch 100 in which the mirror array 200 is arranged at such a tilt angle θ, the coupling carried out between the input port 110a and the port array 110 through the portion of the mirror substrate 202 excluding the movable mirrors 222 is reduced at least approximately 5 dB with respect to the coupling carried out between the input port 110a and the port array 110 through a movable mirror 222 tilted about the axis A1 at the tilt angle θ in a direction heading toward the focusing optical element 170. Accordingly, the wavelength selective switch 100 in which the stray light that is coupled to the port array 110 is reduced is provided.

The control unit 300 tilts each movable mirror 222 in an angular range between a first angular position at which the movable mirror 222 is tilted about the axis A1 at the tilt angle θ in a direction heading toward the focusing optical element 170 and a second angular position at which the same is tilted about the axis A1 at the tilt angle θ in a direction veering off the focusing optical element 170 for the attenuation. As a result, a signal of each channel is attenuated in the range of 0 to approximately 20 dB.

In a conventional wavelength selective switch in which a mirror array is arranged without the tilt angle θ, a movable mirror is tilted to only one side for the attenuation with a non-tilted state being determined as a reference. On the other hand, in the wavelength selective switch 100 according to this embodiment, at the time of the attenuation, the movable mirror 222 is tilted about the axis A1 to both sides with a non-tilted state being determined as a reference. Accordingly, the tilt angle of the movable mirror 222 required for the wavelength selective switch 100 according to this embodiment is a half of the tilt angle of the movable mirror required for the conventional wavelength selective switch.

Since the small mirror array 200 having high performance is demanded, it is formed of an MEMS micro mirror array. In the MEMS micro mirror array, in order to increase a deflection angle (a maximum tilt angle) of each movable mirror 222, a voltage to be applied must be increased and the rigidity of the hinges 224 and 228 must be reduced. This is applied to not only the MEMS micro mirror array but also all mirror arrays each having a configuration in which the movable mirror is supported by the hinges.

However, a reduction in rigidity of the hinges 224 and 228 decreases a resonant frequency of the movable mirror 222. A decrease in resonant frequency of the movable mirror 222 causes the movable mirror 222 to readily exercise unnecessary movement when disturbance such as vibration is given to the wavelength selective switch 100. As a result, a quality of a light signal is lowered.

In the wavelength selective switch 100 according to this embodiment, since the deflection angle required for the movable mirror 222 is reduced by half as compared with the conventional wavelength selective switch, the rigidity of the hinges 224 and 228 can be greatly increased, whereby the resonant frequency of the movable mirror 222 can be increased. As a result, a decrease in quality of the light signal can be reduced with respect to disturbance, e.g., vibration. Additionally, since the deflection angle required for the movable mirror 222 can be reduced, a power consumption of the wavelength selective switch 100 can be decreased.

In the wavelength selective switch 100, in order to prevent signal light from being coupled to an undesired output port 110b other than a switching destination while changing over the output port 110b, the movable mirror 222 may be tilted about the axis A1 so that the signal light is prevented from being coupled to any one of the output ports 110b while changing over the output port 110b. This is called hitless. In the wavelength selective switch 100 that performs such hitless, the tilt angle θ may be set to, e.g., an angle θ3 at which the coupling carried out between the input port 110a and the port array 110 through a movable mirror 222 tilted about the axis A1 at the tilt angle θ in a direction veering off the focusing optical element 170 is reduced approximately 40 dB with respect to the coupling carried out between the input port 110a and the port array 110 through a movable mirror 222 tilted about the axis A1 at the tilt angle θ in a direction heading toward the focusing optical element 170.

Such an angle θ3 is approximately 1.4 times the angle θ2 exemplified in relation to the attenuation. The angle θ3 is, e.g., approximately 4 degrees. This is substantially equal to a maximum deflection angle of the current electrostatic drive type micro mirror. Even in the wavelength selective switch 100 in which the mirror array 200 is arranged at the tilt angle θ that is the angle θ3, the coupling carried out between the input port 110a and the port array 110 through the portion of the mirror substrate 202 excluding the movable mirrors 222 is decreased at least approximately 5 dB with respect to the coupling carried out between the input port 110a and the port array 110 through a movable mirror 222 tilted about the axis A1 at the tilt angle θ in a direction heading toward the focusing optical element 170. Accordingly, the wavelength selective switch 100 in which the stray light coupled to the port array 110 is reduced is provided.

The control unit 300 tilts each movable mirror 222 so that the tilt of the movable mirror 222 is switched between the first angular position at which the movable mirror 222 is tilted about the axis A1 at the tilt angle θ in a direction heading toward the focusing optical element 170 and the second angular position at which the same is tilted about the axis A1 at the tilt angle θ in a direction veering off the focusing optical element 170 at the time of hitless, for example.

Like the attenuation, in the hitless, a deflection angle required for the movable mirror 222 is reduced by half in the wavelength selective switch 100 according to this embodiment as compared with a conventional wavelength switch. Accordingly, a resonant frequency of the movable mirror 222 can be increased in the wavelength selective switch 100. As a result, in the wavelength selective switch 100, a reduction in quality of the light signal with respect to disturbance such as vibration can be decreased, and a power consumption can be reduced.

Further, a speed of an operation of the movable mirror 222 cannot be increased beyond the resonant frequency. That is, an upper limit of an operating speed of the movable mirror 222 is dependent on the resonant frequency. Accordingly, since the resonant frequency of the movable mirror 222 in the wavelength selective switch 100 according to this embodiment can be increased as compared with the conventional wavelength selective switch, a high switching speed can be attained.

In another example, the tilt angle θ may be set to an angle θ4 at which the coupling carried out between the input port 110a and the port array 110 (the input port 110a and the output port 110b) through a non-tilted movable mirror 222 is decreased approximately 40 dB with respect to the coupling carried out between the input port 110a and the port array 110 through a movable mirror 222 tilted about the axis A1 at the tilt angle θ in a direction heading toward the focusing optical element 170.

In such a wavelength selective switch 100 in which the mirror array 200 is arranged at the tilt angle θ that is the angle θ4, the stray light reflected by the portion of the mirror substrate 202 excluding the movable mirrors 222, e.g., the fixed frame 230, the movable frame 226 or the hinges 224 and 228 is not substantially coupled to the port array 110. Accordingly, the wavelength selective switch 100 in which the stray light coupled to the port array 110 is reduced is provided.

Further, when the application of a voltage to the mirror array 200 is stopped due to, e.g., any accident, the movable mirrors 222 return to a non-tilted state. The signal light reflected by the non-tilted movable mirrors 222 is not substantially coupled to the port array 110. Accordingly, even when the application of a voltage to the mirror array 200 is unexpectedly stopped, the signal light is not coupled to an undesired output port 110b. This is called a normal off state.

Arranging the mirror array 200 at the tilt angle θ that is the angle θ4 in this manner enables obtaining the wavelength selective switch 100 having the normal off function by which the coupling of the stray light to the output port 110b becomes 40 dB or below with respect to preferable coupling when a voltage is not applied to the mirror array 200.

Although the embodiment according to the present invention has been described with reference to the accompanying drawings, the present invention is not restricted thereto, and various modifications or changes can be carried out without departing from the scope of the invention.

What is claimed is:

1. A wavelength selective switch comprising:
a port array including three or more input and output ports arranged on a first plane in which a first axis and a second axis perpendicular to the first axis lie and aligned along the first axis, at least one input port launching a light beam in substantially parallel to the second axis;
a dispersive element to disperse the light beam launched from the input port in a plane that is substantially parallel to a second plane in which a third axis perpendicular to the first axis and the second axis and the second axis lie;
a focusing optical element to focus light beams dispersed by the dispersive element; and
a mirror array to selectively couple the light beams focused by the focusing optical element to at least one output port through the focusing optical element and the dispersive element,
the mirror array having a mirror substrate arranged across the second plane, the mirror substrate including movable mirrors that are arranged in a line and allowed to be two-dimensionally tilted and being arranged so that its surface facing the focusing optical element has a tilt angle about an axis substantially parallel to the first axis with respect to a third plane in which the third axis and the first axis lie.

2. The switch according to claim 1, wherein the mirror array includes a driving substrate configured to drive the movable mirrors, and the driving substrate is arranged in substantially parallel to the mirror substrate, so that the driving substrate is arranged so that its surface facing the mirror substrate has a tilt angle about the axis parallel to the first axis with respect to the third plane in which the third axis and the first axis lie.

3. The switch according to claim 2, wherein the mirror substrate comprises, for each of the movable mirrors, a movable frame placed around a movable mirror, a pair of first hinges connecting the movable mirror and the movable frame, a fixed frame placed around the movable frame, and a pair of second hinges connecting the movable frame with the fixed frame, the first hinges support the movable mirror to allow it to be tilted about a first tilt axis with respect to the movable frame, the second hinges support the movable frame to allow it to be tilted about a second tilt axis with respect to the fixed frame, and the first tilt axis is substantially parallel to the first plane.

4. The switch according to claim 1, wherein the tilt angle is a half of a deflection angle required for attenuation.

5. The switch according to claim 1, wherein the tilt angle is a half of a deflection angle required for hitless.

6. The switch according to claim 1, wherein the tilt angle is an angle at which the light beam reflected by a non-tilted movable mirror substantially deviates from the output port.

7. The switch according to claim 3, wherein the tilt angle is an angle at which coupling carried out between the input port and the port array through the portion of the mirror substrate excluding the movable mirrors is decreased at least approximately 5 dB with respect to coupling carried out between the input port and the port array through a movable mirror tilted about the first tilt axis at the tilt angle in a direction heading toward the focusing optical element.

8. The switch according to claim 3, wherein the tilt angle is an angle at which coupling carried out between the input and output ports through a movable mirror tilted about the first tilt axis at the tilt angle in a direction veering off the focusing optical element is decreased approximately 20 dB with respect to coupling carried out between the input port and the port array through a movable mirror tilted about the first tilt axis at the tilt angle in a direction heading toward the focusing optical element.

9. The switch according to claim 3, wherein the tilt angle is an angle at which coupling carried out between the input port and the port array through a movable mirror tilted about the first tilt axis at the tilt angle in a direction veering off the focusing optical element is decreased approximately 40 dB with respect to coupling carried out between the input and output ports through a movable mirror tilted about the first tilt axis at the tilt angle in a direction heading toward the focusing optical element.

10. The switch according to claim 3, wherein the tilt angle is an angle at which coupling carried out between the input port and the port array through a non-tilted movable mirror is decreased approximately 40 dB with respect to coupling through a movable mirror tilted about the first tilt axis at the tilt angle in a direction heading toward the focusing optical element.

11. The switch according to claim 3, further comprising a control unit configured to drive the movable mirrors, wherein the control unit tilts each movable mirror so that the tilt of the movable mirror is switched between a first angular position at which the movable mirror is tilted about the first tilt axis at the tilt angle in a direction heading toward the focusing optical element and a second angular position at which the movable mirror is tilted about the first tilt axis at the tilt angle in a direction veering off the focusing optical element.
